(19) United States
(12) Patent Application Publication
(10) Pub. No.: US 2026/0061389 A1
(43) Pub. Date: Mar. 5, 2026

(54) MANUFACTURE OF GRAPHENE AND LARGE GRAPHENE ELECTRODES

(71) Applicant: Rodolfo Antonio M. Gomez, South Australia (AU)

(72) Inventor: Rodolfo Antonio M. Gomez, South Australia (AU)

(21) Appl. No.: 18/871,008

(22) PCT Filed: Jun. 20, 2024
(86) PCT No.: PCT/AU2024/050648

§ 371 Date: Dec. 2, 2024

(30) Foreign Application Priority Data
May 9, 2023 (AU) 2023901394

(51) Int. Cl. B01J 19/12; B01J 19/00; C01B 32/184; C25B 11/03; C25B 11/043

(52) U.S. Cl. CPC B01J 19/121; B01J 19/0013; C01B 32/184; B01J 2219/00132; B01J 2219/0871; B01J 2219/0883; B01J 2219/0892; B01J 2219/12; C25B 11/03; C25B 11/043

(57) ABSTRACT

The present invention concerns the fabrication of large graphene electrodes. In the electrolysis of water or in the operation of a hydrogen fuel cell. the electrical conductivity is important to reduce the energy consumption. Titanium electrodes are widely used but their conductivity is only about 4% of copper. Graphene is 70% more conductive than copper and is chemically stable provided there are no metal ions in the electrolyte. By irradiating a mixture of carbon dioxide gas and hydrogen gas quantities of graphene can readily be produced which can then be manufactured into large electrodes by way of the described press formation.

### TECHNICAL FIELD

The field of the invention relates to the production and manufacture of electrodes, and in particular to graphene electrodes

This application claims priority from AU 2023901394 filed on 9 May 2023, the entire content is hereby incorporated by reference.

### BACKGROUND

Unipolar electrolysis of water is an advanced process to produce low-cost green hydrogen, as exemplified in granted U.S. Pat. No. 10,316,416. While the energy required in the hydrolysis process has been reduced substantially from 53.4 kilowatt-hours per kilogram in earlier conventional hydrolysis process to as low as 6.13 kilowatt-hours per kilogram in Unipoloar electrolysis, the current required to produce hydrogen electrolytically must follow Faraday's law that requires 96,484.3 coulombs (ampere seconds) to produce 1 gram of hydrogen.

Solar generated energy, the process of converting sunlight into electrical energy wither though the use of photovoltaic cells or the sunlight concentration systems whilst being clean, is limited by the availability of sunlight at any given location, which is around about 10 hours per day. To supply hydrogen for a 200 megawatt (MW) fuel cell, 96 copper electrodes of 3 metres×3 metres size would be required with each electrode carrying about 200,000 amperes. This is a large amount of copper required and the copper has to be protected by a coating, such as ruthenium/iridium coating, and then platinum particles must be applied to the surface of the electrodes.

The largest manufacturer of graphene is Daikin of Japan who manufacture about 80 tonnes of nanotube graphene a year. Another Australian manufacturer is Graphene Manufacturing Group who make graphene coated aluminium sheets for heat exchange equipment and aluminium graphene batteries. There is however little work, if any, in the area of interest of large electrolytic electrodes.

Conventionally, graphene can be manufactured from naturally occurring graphite by a laborious processing method. Alternatively, for example, it is known to use an electric plasma process to split natural gas into graphene and hydrogen.

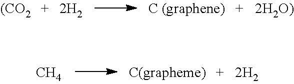

There is however a need for an increase in the scaled production of graphene that is more energy efficient and suitable for widespread use.

### SUMMARY OF INVENTION

In some embodiments, the present invention is directed to a method or system of producing graphene, by exposing CO₂ and hydrogen to a laser source. In some embodiments, the CO₂ and hydrogen are exposed to a laser source in a reactor chamber.

In some embodiments, the present invention is directed towards a method for converting a mixture of CO₂ and hydrogen into graphene by providing a mixture of CO₂ and hydrogen into a reaction vessel, irradiating the mixture of CO₂ and hydrogen with at least one laser beam to heat the mixture of CO₂ and hydrogen to convert the mixture of CO₂ to graphene.

In some embodiments, the reaction vessel includes a catalyst, and the at least one laser beam heat the mixture of CO₂ and hydrogen with the catalyst to convert the mixture of CO₂ to graphene.

In some embodiments, the at least one laser beam heats a surface of the catalyst to convert the CO₂ in the mixture of mixture of CO₂ and hydrogen to graphene.

In some embodiments, the reaction vessel includes additional sources of heat, for example an electric plasma source, microwave energy source.

In some embodiments, the carbon raw material such as carbon paper or carbon from brown coal are first moulded with the diamond holes before intense heat is applied such as from microwaves, lasers or electric plasma.

In some embodiment, the moulds may consist of a fixed bottom mould and a moving upper mould.

In some embodiment, the moulds may be a set of rollers with indentations to create the diamond holes in the electrode before intense heat is applied such as from microwaves, lasers, or electric plasma.

A further aspect of the inventions reside in a method of forming a mesh electrode the method including: preparing and assembling a plurality of sheets of electrically conductive material to form a stack of sheets; compressing the stack of sheets using a press to produced a compressed stack of sheets, the press having pressing plates with a surface having a pattern to press openings into the compressed stack of sheets to produce a compressed stack of sheets with a mesh pattern.

Other aspects of the invention are when the electrically conductive material is carbon, and the compressed stack of sheets with mesh pattern are introduced to a reaction vessel, are irradiated with laser radiation from a laser to heat the reaction vessel to a temperature in the range of 400° C. and 900° C. to convert the compressed stack of carbon sheets with mesh pattern to a stack of graphene sheets with mesh pattern.

Further forms of the invention will be apparent from the description and drawings.

### BRIEF DESCRIPTION OF THE DRAWINGS

Embodiments of the present invention will now be better understood and apparent to a person of ordinary skill in the art refereeing to the written description, by way of example only, in conjunction with the drawing, in which:

FIG. 1 shows a diagrammatic representation of the present invention for producing graphene from mixture of CO₂ and hydrogen using a laser in accordance with some embodiments;

FIG. 2 shows a diagrammatic representation of the present invention for producing graphene from mixture of CO₂ and hydrogen using a laser in conjunction with additional sources of heat, in accordance with some embodiments;

FIG. 3 shows a cross section along A-A of the electrode showing in FIG. 2.

FIG. 4a shows side view of a linear rector with a plurality of arranged laser emitting devices, arranged to provide different wavelengths of laser radiation to a carbon sheet;

FIG. 4b is a plan view of the linear reactor shown in FIG. 4a;

FIG. 5 is a view of a press used to produce suitable pressed graphene paper material to form an electrode;

FIG. 6 is a view of an embodiment of the mesh produced from the press of FIG. 5 with a magnified portion showing the mesh configuration;

FIG. 7 is a side view of a roller press used to produce graphene sheets of the present invention.

### DESCRIPTION

The purpose of this invention is to fabricate grapheme electrodes that are 10 to 30 mm thick and 500 to 1,000 mm wide and 2,000 to 3,000 mm long. The electrode will have diamond shape openings similar to an expanded metal so that the electrolyte can move from one side of the electrode to the other side throughout the electrode with the aid of baffles.

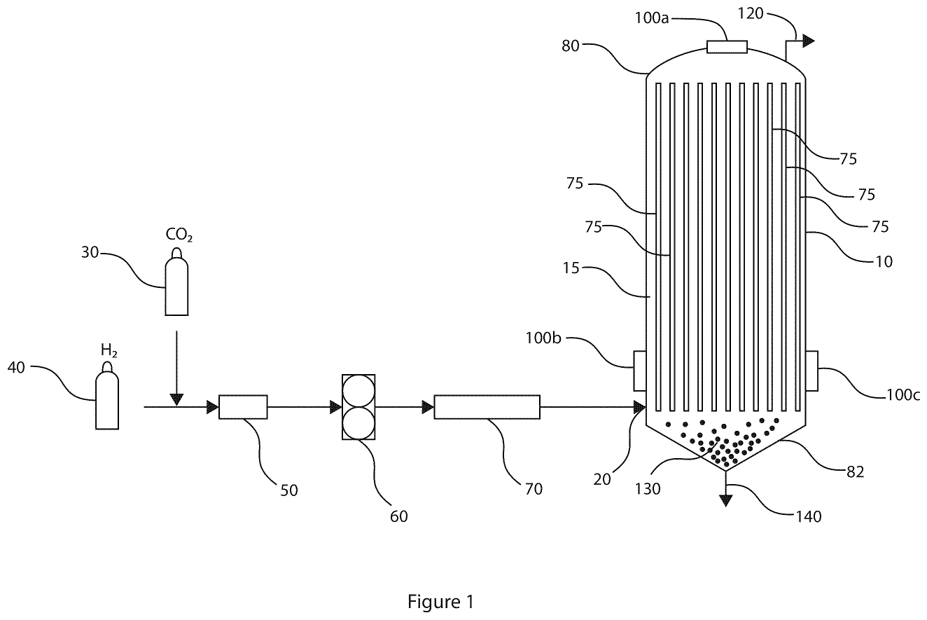

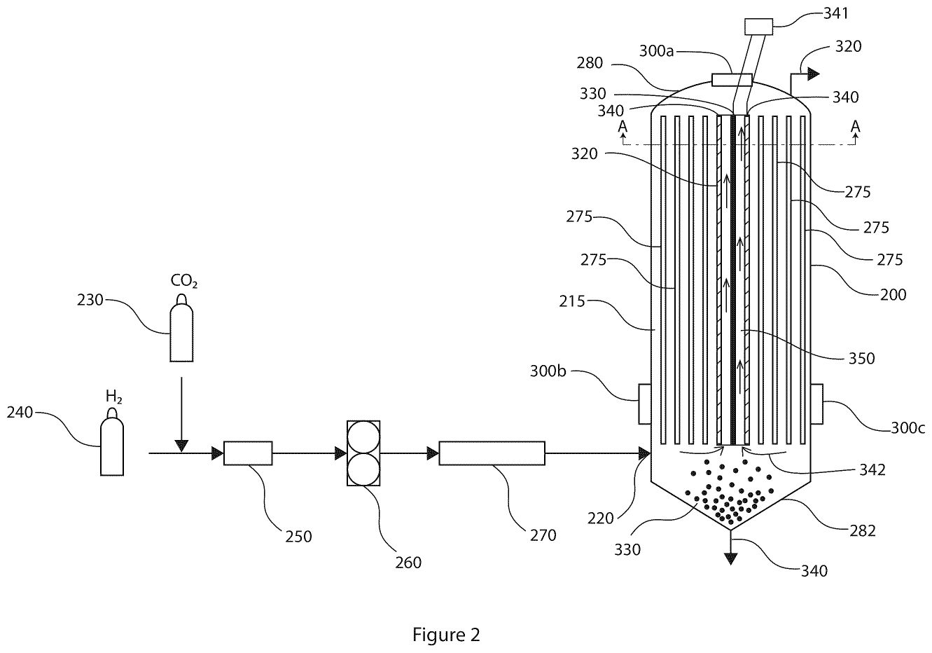

The graphene electrodes can be made by 3 methods:
1. Fine particles of grapheme are fabricated reacting methane or carbon dioxide and hydrogen in a chamber with high intensity lasers or electric plasma as shown in FIGS. 1 and 2. The fine graphene powder mixed with a suitable binder is placed in a mould to produce the graphene electrode. In this mould, the material is subjected to intense microwave, or lasers or electric plasma, so that even the binder is converted to graphene. The carbon dioxide and hydrogen can be produced from my U.S. Pat. No. 7,182,851 “Electrolytic Commercial Production of Hydrogen from Hydrocarbon Compounds” using brown coal as a feedstock.
2. Another method is to use carbon paper that is commercially available in different thicknesses. The carbon paper can be layered to the thickness required from 10 to 30 mm. The diamond holes can be cut before the carbon paper is subjected to intense microwave, or laser or electric plasma. Some appropriate glue that converts to graphene may be used to bind the carbon paper together.
3. The other method is to process brown coal with my U.S. Pat. No. 9,187,697 “Advanced Coal Upgrading Process for a Power Plant” where brown coal is subjected to microwave energy to produce a gas, liquid and solid. The solid is almost pure carbon and it becomes the raw material to be subjected to intense lasers or microwave or electric plasma in a mould that has the diamond shape openings.

The production of carbon (graphene) can be achieved by the following reaction, although in conventional process this requires a substantial amount of energy, pressure and heat:

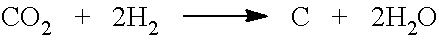

FIG. 1 shows a system/method of the present invention in which the reaction, according to one embodiment of the present invention, coverts the CO₂ into graphene powder using lasers, high temperature (above 550° C.) and pressure with catalyst such as iron oxide, strontium oxide and others.

The reactor 10, with an inner chamber 15, has an input conduit 20 though which a metered amount of a mixture of CO₂ and hydrogen is supplied to the inner chamber 15. Gaseous CO₂ 30 and hydrogen 40, from a commercial supply source, are fed into a mixing chamber 50 in predefined amounts, for example in a ration of CO₂:H₂ 1:2 and mixed for a predetermined amount of time before being directed to a gas compressor 60 that operates to compress the gas to a working state. Once compressed to the desired pressure, the compressed gas mixture of CO₂ and H₂ is then pre-heated in a heater unit 70 to a predefined temperature, and then supplied to the interior chamber 15 of the reactor 10.

Within the interior chamber 15 of the reactor 10 are a plurality of catalyst rods 75, such as iron oxide, strontium oxide and others, arranged in parallel, colinear with a longitudinal axis of the reactor 10.

The laser source will be a laser that can operate in a continuous or in a pulsed mode. The laser device can be a high powered laser, for example, not limiting, a gas laser such as a CO₂ laser, argon laser, metal ion laser, solid state lasers, that use a crystalline or glass rod that is “doped” with ions that provide the required energy states, or a combination of two or more such lasers. It may be preferable to select the laser source in accordance with economic factors, to keep productions costs low. An example of an economical laser is a CO₂ laser.

Positioned at an upper end 80 of the reactor 10 is a laser 100a, configured to emit laser radiation, such as a CO₂ laser. The laser 100a is orientated to emit laser radiation downwards and into the chamber 15 with the rods of catalyst 75, to cause the reaction:

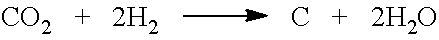

Additional laser radiation emitting units 100b and 100c are positioned towards a lower end of the reaction vessel 10 to increase production yields.

Water is produced in the form of vapour, due to the internal temperature of the reaction, and is vented off via the valve 110. The carbon material 130, in the form of graphene powder then collects in the lower end 82 of the reactor 10, away from the sources of laser radiation and can be collected via the conduit 140.

In certain embodiments, the laser will be configured to irradiate the surface of a catalyst inside the reactor to facilitate the conversion of the CO₂ to graphene.

In certain embodiments, the temperature of the catalyst or interior reactor chamber will be heated to about 400° C., about 450° C., about 500° C., about 550° C., about 600° C., about 650° C., about 700° C., about 750° C., about 800° C., about 850° C., about 900° C.

In some embodiments, the laser may be pre-set to irradiate the reactor chamber and the catalyst for a predetermined period of time.

In some embodiments, the laser may be pre-set to irradiate the reactor chamber and/or the catalyst for a predetermined period of time.

In some embodiments, the catalyst is iron oxide, strontium oxide, copper oxide, or mixtures thereof. In other embodiments, the catalyst is a metal catalyst, such as aluminium, zinc or magnesium.

FIG. 2 shows a reactor using electric plasma and microwaves in addition to high power lasers.

The reaction 200 has an interior chamber 215 with an input conduit 220 though which a metered amount of a mixture of CO₂ and hydrogen is supplied to the inner chamber 215. Gaseous CO₂ 230 and hydrogen 240, from a commercial supply source, are fed into a mixing chamber 250 in predefined amounts, for example in a ratio of CO₂:H₂ 1:2 and mixed for a predetermined amount of time before being directed to a gas compressor 260 that operates to compress the gas mixture to a working state. Once compressed to the desired pressure, the compressed gas mixture of CO₂ and H₂ is then pre-heated in a heater unit 270 to a predefined temperature, and then supplied to the interior chamber 215 of the reactor 200.

The laser source will be a laser that can operate in a continuous or in a pulsed mode. The laser device can be a high powered laser, for example, not limiting, a gas laser such as a CO₂ laser, argon laser, metal ion laser, solid state lasers, that use a crystalline or glass rod that is “doped” with ions that provide the required energy states, or a combination of two or more such lasers. It may be preferable to select the laser source in accordance with economic factors, to keep productions costs low. An example of an economical laser is a CO₂ laser.

Positioned at an upper end 280 of the reactor 200 is a laser 300a, configured to emit laser radiation, such as a CO₂ laser. The laser 300a is orientated to emit laser radiation downwards and into the chamber 215 with the rods of catalyst 275, to cause the reaction:

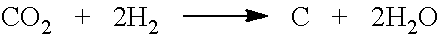

Additional laser radiation emitting units 300b and 300c are positioned towards a lower end of the reaction vessel 200 to increase production yields.

Positioned in the center of the reaction vessel 200 is a high voltage electrode 320 having a positive electrode (anode) 330 surrounded by a negative electrode (cathode) 340, in the form of a hollow cylinder, operatively connected to a power supply 341. The CO₂/H₂ mixture is drawn up 342 by convection where it is exposed to the high voltage environment, the mixture of carbon dioxide gas and hydrogen gas in the interior chamber of the high voltage electrode is subjected to a continuous electric arc between the two electrodes to heat the mixture of carbon dioxide gas and hydrogen gas within the interior 350 of the high voltage electrode 320. Carbon, in the form of graphene, 330 collects in the lower end 282 of the reactor 200 and can be collected via the conduit 340, while water vapour is vented off via the valve 320.

the mixture of carbon dioxide gas and hydrogen gas in the interior chamber of the high voltage electrode is subjected to a continuous electric arc between the two electrodes to heat the mixture of carbon dioxide gas and hydrogen gas

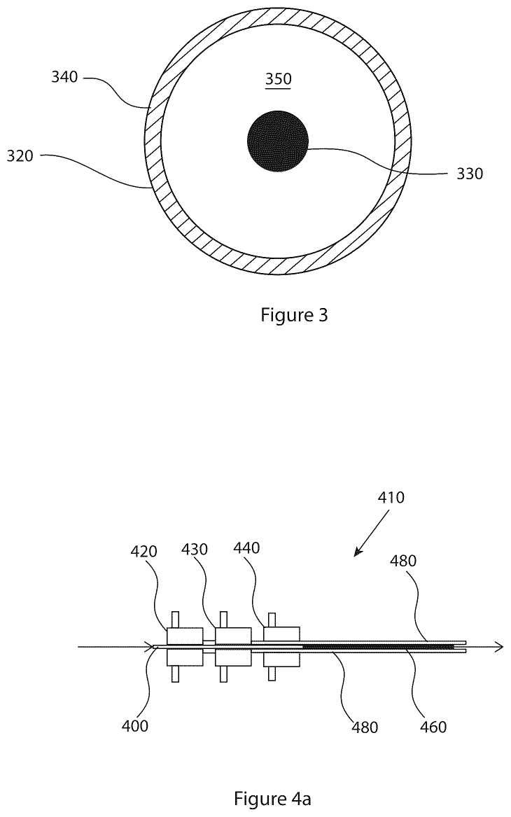

FIG. 3 shows a cross section of the high voltage electrode 320 along A-A from FIG. 2

In some embodiments, a microwave emitting unit, such as a klystron microwave unit operating in the 8-14 GHz rang can be located on the lower end 282 of the reactor 200 to provide additional energy into the reactor chamber, the microwave emitting unit operating though a quartz window, or other suitable opening into the chamber 215 of the reactor 200.

The graphene powder obtained from the present reactor 10 or 200 can then be used in the manufacture of graphene sheets, which in turn can then be formed into electrodes.

For example, the graphene can be applied to a sheet material by electrodeposition, chemical vapour deposition (CVD) solution phase deposition, electroless deposition or hot pressing of graphene containing slurry on to sheet material. Techniques such as drop casting, spin coating, dip coating or spray coating may be used.

Graphene sheet can also be obtained by subjecting carbon paper to exposure to laser radiation, in the presence of hydrogen, the carbon in the carbon paper being converted to graphene. In addition, carbon from brown coal may be utilized to form the carbon paper,

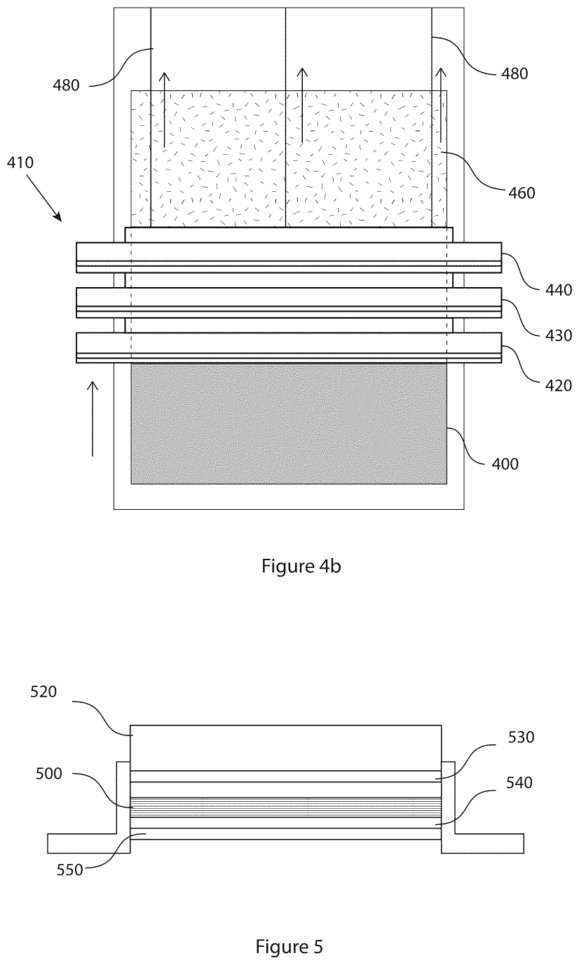

As shown in the FIGS. 4a and 4b, a carbon sheet 400, is fed into a linear reactor 410, that has a plurality of laser emitting devices, 420, 430 and 440. In some embodiments the laser emitting devices are all the same laser emitting devices, for example a CO₂ laser, each emitting laser radiation at the same, or substantially the same wavelength. In other embodiments, the laser emitting devices, 420, 430 and 440 may each be a separate laser emitting device, for example three separate CO₂ lasers, each being tunes to supply laser radiation at different wavelengths. In yet other embodiments, the high power lasers are arranged from lower frequency at the bottom to the highest frequency at the top. The lasers may be pulsing or continuous.

In yet other embodiments, the laser emitting device 420 emits radiation at approximately, 532 nm (green), laser emitting device 430 emits radiation at approximately, 589 nm (yellow), and laser emitting device 440 emits radiation at approximately, 445 nm (blue). The laser irradiation of the carbon material on the carbon sheet converts the carbon to graphene, to produce the graphene sheet 460, which is then guided out of the linear reactor via the soft guides 480.

The graphene powder obtained using reactors 10 and 200 can be converted to sheets and then formed into electrodes according to FIG. 5.

Once the graphene sheets 460 are formed, they are glued together using an electrically conductive glue, for example, a glue that contains silver, graphite, nickel, copper or other suitably electrically conductive material. Such glues are known to those skilled in the art and can be purchased commercially, for example, but not limited to, MasterBond® EP75-1. For example, a stack 500 of graphene sheets 460 is formed from layers on top of each other, and compacted using a press 510 with a moving plate 520 with impression mesh 530, with hills and valleys, and a static plate 540 with impression mesh 550. Pressing the moving plate 520 towards the static plate 540, compressing the stack 500, results in the formation of a diamond pattern on the consolidated/compressed stack 500 of a grid like pattern, the compressed stack being approximately 12-16 mm thick. Die punching may also be used, dependent on the size of the punches on the perforation plate to create the appropriate sized opening in the stack 500.

The consolidated/compressed stack 600 produced from the press 510 has a pattern with diamond shaped openings 610.

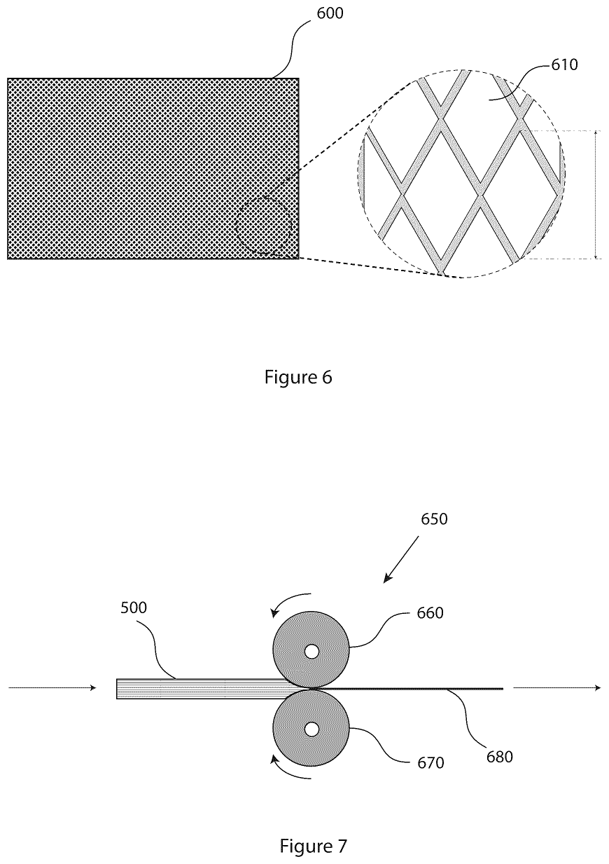

FIG. 7 shows another method of compressing the stack 500 with a roller press 650. The roller press 650 has an upper roller 660 and lower roller 670 that work in combination to compress the stack 500 to a specified height through the contrarotation of the rollers 660 and 670. The height between the rollers 660 and 670 (changes the nip) may be adjustable to provide a compressed stack 680. The upper roller 660 and lower roller 670 each have a pattern on their surface that imprints on the stack 500 as it is drawn in to create a mesh electrode structure 600 the same as that shown in FIG. 6. These types of rollers have mating rotating cylinders, one with a series of projections (male die), the other with a series of indentations (female die) that operate in alignment with each other so that in operation the male die punches out a shape in the stack 500. In some embodiments, there can be a male die rotating against an anvil roller. Advantageously, the roller press 650 can create a mesh electrode 600 of variable lengths, dependent on the length of the length of the stack 500 being feed into it.

In a further embodiment, the rollers 650 can be used to compress sheets of carbon paper, that is paper of paper like mater that has applied to it via deposition a layer or layers of carbon material to each of its surfaces. For example, film deposition, liquid deposition, liquid/solution coating can be used to apply a layer of carbon material to both an upper and lower surface of a paper/per like material of film, for example a polyethylene film, and then left to cure/dry to form a carbon coated/impregnated sheet. The cured/dried carbon coated/impregnated sheet can then be layers to form a stack of cured/dried carbon coated/impregnated sheets and then fed into a press or roller press, like those of FIGS. 5 and 6, and compressed and imprinted with a diamond grid pattern to produce a carbon mesh sheet.

The carbon mesh sheet can then be subjected to intense heat using one of, or a combination of microwave lasers, lasers, electric plasma that converts the carbon material on the carbon mesh sheet to graphene, thus producing a graphene mesh sheet that can be used as a graphene electrode.

In some embodiments, platinum particles can be applied to the surface of the graphene sheets produced from any of the methods described above

The compacted electrode may be subjected to heat, laser, microwave to complete the curing of the glue. The glue used to consolidate the compacted material may include a curing agent, such as a heat or light curing agent, to facilitate the curing process.

Another aspect of the present invention is the doping of the graphene with metal ions such as hydrogen ions, copper ions, chromium ions, and/or rare earth ions such as lanthanum ions and cerium ions. The addition of the added metal ions in the graphene structure creates a graphene-metal hybrid structure that allows electrons in the graphene-metal structure to move may more freely, resulting in higher current capacity of the doped graphene-metal hybrid.

As described, certain aspects of the invention include a method for converting carbon dioxide to graphene, the method including,
injecting a mixture of carbon dioxide gas and hydrogen gas into a reaction vessel;
the reaction vessel including a plurality of rods of catalytic material;
irradiating the mixture of carbon dioxide gas and hydrogen gas with laser radiation from a laser to heat the reaction vessel to a temperature in the range of 400° C. and 900° C.;
to convert the carbon dioxide gas mixture to solid graphene.

In some aspects, the plurality of rods of catalytic material are rods made from a catalytic material of iron oxide or strontium oxide. The laser is a carbon dioxide laser, in some aspects the laser radiation is produced from the laser is a continuous laser or a pulsed laser.

In some aspects, the mixture of carbon dioxide gas and hydrogen gas is preheated prior to injection into the reaction vessel. The graphene produced by conversion of the carbon dioxide gas mixture falls under gravity to a lower portion of the reaction vessel for removal. In other aspects, the injection of the mixture of carbon dioxide gas and hydrogen gas into a reaction vessel can be continuous during the irradiation.

In further aspects of the invention, the reaction vessel includes a high voltage electrode. It can be a hollow cylindrical electrode, with an opening at both ends. The electrode comprises a positive anode core surrounded by a negative cathode cylinder. The mixture of carbon dioxide gas and hydrogen gas injected into the reaction vessel is drawn up and into an interior chamber of the high voltage electrode. There it is subjected to a continuous electric arc between the two electrodes to heat the mixture of carbon dioxide gas and hydrogen gas and exits the hollow cylindrical electrode and is then irradiated by the laser radiation from the laser in the present of the catalytic rods.

In another embodiment of this invention, the electrodes may be made of borophene. While little is known of borophene at this stage, early knowledge is that borophene also has a high electrical conductivity that makes it suitable as an electrode.

Borophene is an allotropic form of carbon that can exist in 2-dimensional and 3-dimensional structures. Its structure has been observed to be analogous to that of graphene and has a high electroactive surface area and high electron mobility.

A borophene sheet or borophone doped sheet such as a borophone doped graphene sheet can be prepared and subjected to the process of pressing and diamond hole pattern forming as outlined in FIG. 5-7.

1. A method for converting carbon dioxide to graphene, the method including,
injecting a mixture of carbon dioxide gas and hydrogen gas into a reaction vessel;
the reaction vessel including a plurality of rods of catalytic material;
irradiating the mixture of carbon dioxide gas and hydrogen gas with laser radiation from a laser to heat the reaction vessel to a temperature in the range of 400° C. and 900° C.;
to convert the carbon dioxide gas mixture to a solid graphene powder.

2. The method of claim 2, wherein the plurality of rods of catalytic material are rods made from a catalytic material of iron oxide or strontium oxide.

3. The method of claim 1, wherein the laser is a carbon dioxide laser.

4. The method of claim 1, wherein the laser radiation is produced from the laser is a continuous laser or a pulsed laser.

5. The method of claim 1, wherein the mixture of carbon dioxide gas and hydrogen gas is preheated prior to injection into the reaction vessel.

6. The method of claim 1, wherein the graphene produced by conversion of the carbon dioxide gas mixture falls under gravity to a lower portion of the reaction vessel for removal.

7. The method of claim 1, wherein the injection of the mixture of carbon dioxide gas and hydrogen gas into a reaction vessel can be continuous during the irradiation.

8. The method of claim 1, wherein the reaction vessel includes a high voltage electrode.

9. The method of claim 8, wherein the electrode is a hollow cylindrical electrode.

10. The method of claim 9, wherein the cylindrical electrode is open at both ends.

11. The method of claim 10, wherein the electrode comprises a positive anode core surrounded by a negative cathode cylinder.

12. The method of claim 10, wherein the mixture of carbon dioxide gas and hydrogen gas injected into the reaction vessel is drawn up and into an interior chamber of the high voltage electrode.

13. The method of claim 12, wherein the mixture of carbon dioxide gas and hydrogen gas in the interior chamber of the high voltage electrode is subjected to a continuous electric arc between the two electrodes to heat the mixture of carbon dioxide gas and hydrogen gas.

14. The method of claim 13, wherein the heated mixture of carbon dioxide gas and hydrogen gas exits the hollow cylindrical electrode and is then irradiated by the laser radiation from the laser in the present of the catalytic rods, where the carbon dioxide gas mixture is converted to graphene.

15. The method of claim 1, where the graphene powder of or carbon paper or carbon from brown coal is fed to a set of cylindrical moulds with valleys and hills to form the electrode with the diamond shaped holes and intense heat from microwaves or lasers or electric plasma is applied to form the graphene electrode.

16. The method of claim 1, where the graphene powder or carbon paper or carbon from brown coal is moulded with a fixed lower mould and a moving upper mould with valleys and hills to form the electrode with the required thickness and diamond shaped holes before intense heat is applied using microwaves, or lasers or electric plasma to produce the graphene electrode.

17. A method of forming a mesh electrode the method including:
preparing and assembling a plurality of sheets of electrically conductive material to form a stack of sheets;
compressing the stack of sheets using a press to produced a compressed stack of sheets, the press having pressing plates with a surface having a pattern to press openings into the compressed stack of sheets to produce a compressed stack of sheets with a mesh pattern.

18. The method of claim 17, wherein the pressing plates are a pair of counterrotating rollers.

19. The method of claim 17, wherein the electrically conductive material is at least one selected from the group of carbon, graphene, borophene.

20. The method of claim 19, wherein when the electrically conductive material is carbon, and the compressed stack of sheets with mesh pattern are introduced to a reaction vessel, are irradiated with laser radiation from a laser to heat the reaction vessel to a temperature in the range of 400° C. and 900° C. to convert the compressed stack of carbon sheets with mesh pattern to a stack of graphene sheets with mesh pattern.
